(19) United States
(12) Patent Application Publication
(10) Pub. No.: US 2026/0064941 A1
(43) Pub. Date: Mar. 5, 2026

(54) SYSTEM FOR FACILITATING TEXT EDITING

(71) Applicant: Capital One Services, LLC, McLean, VA (US)

(72) Inventor: Bryan TAMAYO, Allen, TX (US)

(21) Appl. No.: 18/816,737

(22) Filed: Aug. 27, 2024

(51) Int. Cl. G06F 40/166; G06F 40/197

(52) U.S. Cl. CPC G06F 40/166; G06F 40/197

(57) ABSTRACT

Some implementations described herein include a system for facilitating text editing. The system obtains, from a user device, user selection input associated with text content that is displayed on the user device via a user interface of the user device. The system identifies, based on the user selection input, a portion of the text content. The system determines editing information associated with the portion of text content, wherein the editing information includes analysis information associated with the portion of the text content and version information associated with the portion of the text content. The system transmits the editing information to the user device to cause the user device to display, via the user interface, the editing information.

### BACKGROUND

A text editor allows users to create, modify, and format text, offering tools like cut, copy, paste, and undo for efficient editing.

### SUMMARY

Some implementations described herein relate to a system for facilitating text editing. The system may include one or more memories and one or more processors communicatively coupled to the one or more memories. The one or more processors may be configured to obtain, from a user device, user selection input associated with text content that is displayed on the user device via a user interface of the user device. The one or more processors may be configured to identify, based on the user selection input, a portion of the text content. The one or more processors may be configured to determine editing information associated with the portion of text content, wherein the editing information includes analysis information associated with the portion of the text content and version information associated with the portion of the text content. The one or more processors may be configured to transmit the editing information to the user device to cause the user device to display, via the user interface, the editing information.

Some implementations described herein relate to a non-transitory computer-readable medium that stores a set of instructions. The set of instructions, when executed by one or more processors of a system, may cause the system to identify a portion of text content that is displayed on a user device via a user interface of the user device. The set of instructions, when executed by one or more processors of the system, may cause the system to determine editing information associated with the portion of the text content, wherein the editing information includes analysis information associated with the portion of the text content and version information associated with the portion of the text content. The set of instructions, when executed by one or more processors of the system, may cause the system to transmit the editing information to the user device to enable the user device to display, via the user interface, the editing information.

Some implementations described herein relate to a method. The method may include displaying, by a user device and via a user interface of the user device, text content. The method may include obtaining, by the user device and based on displaying the text content, user selection input that indicates a portion of the text content. The method may include transmitting, by the user device, the user selection input to a system. The method may include receiving, by the user device and based on transmitting the user selection input, editing information associated with the portion of the text content, wherein the editing information includes analysis information associated with the portion of the text content and version information associated with the portion of the text content. The method may include displaying, by the user device and via the user interface of the user device, the editing information.

### BRIEF DESCRIPTION OF THE DRAWINGS

FIGS. 1A-1G are diagrams of an example implementation associated with a system for facilitating text editing, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with a system for facilitating text editing, in accordance with some embodiments of the present disclosure.

FIG. 4 is a flowchart of an example process associated with a system for facilitating text editing, in accordance with some embodiments of the present disclosure.

FIG. 5 is a flowchart of an example process associated with a system for facilitating text editing, in accordance with some embodiments of the present disclosure.

### DETAILED DESCRIPTION

The following detailed description of example implementations refers to the accompanying drawings. The same reference numbers in different drawings may identify the same or similar elements.

A user device can include a text editor, or other application, to facilitate text editing. However, the text editor provides a linear, single-view editing process, where only updates to text are retained. Consequently, previous versions or alternate versions of the text are lost or deleted (e.g., as a result of not being retained).

In some cases, an edit tracking feature can be enabled in the text editor, but such a feature only displays accumulated edits to a text (e.g., a difference between the text at a first time and at a second time) and does not allow for viewing of multiple previous versions of the text or any alternate versions of the text. Consequently, the text editor cannot provide certain editing-related information associated with the text to the user (or any other user that is to edit the text). This therefore can inhibit the user's ability to efficiently review and edit the text, which therefore causes the user to spend more time to review and edit the text. Consequently, additional computing resources (e.g., processing resources, memory resources, communication resources, and/or power resources, among other examples) of the user device are utilized to enable more time to review and edit the text.

Some implementations described herein include a text editing system. The text editing system is configured to facilitate editing of a portion of text content that is displayed on a user device (via a user interface of the user device). The text content may include one or more alphanumeric characters, one or more words, one or more paragraphs, and/or other text content, and the portion of the text content may include some or all of the text content.

In some implementations, the text editing system obtains user selection input, which indicates the portion of the text content. The text editing system thereby identifies the portion of the text content and determines editing information associated with the portion of the text content. The editing information includes analysis information associated with the portion of the text content and version information associated with the portion of the text content. The analysis information may include, for example, a score that indicates a quality of the portion of the text content and/or one or more edit suggestions associated with the portion of the text content, as further described herein. The version information may include, for example, primary version information (e.g., that includes at least a latest saved primary version of the portion of the text content) and/or alternate version information (e.g., that includes one or more saved alternate versions of the portion of the text content), as further described herein. The text editing system then transmits the editing information to the user device, which allows the user device to display the editing information (e.g., contemporaneously with the portion of the text content).

In this way, the editing information is displayed to a user of the user device to facilitate editing of the portion of the text content. For example, the user can view the score and the one or more edit suggestions to determine how to edit the portion of the text content (e.g., to increase a quality of the portion of the text content). As another example, the user can view the primary version information (e.g., that includes at least the latest saved primary version of the portion of the text content) and the alternate version information (e.g., that includes one or more saved alternate versions of the portion of the text content) to select another version of the portion of the text content (e.g., as the current version of the text content) and/or to inform the user's editing choices related to the portion of the text content.

Accordingly, some implementations described herein provide editing-related information associated with the portion of the text content that cannot otherwise be provided (e.g., using a typical text editor with an edit tracking functionality). The user of the user device therefore is provided additional, relevant information that increases the user's ability to efficiently review and edit the portion of the text content. Thus, the user device spends less time to review and edit the portion of the text content. Therefore, fewer computing resources (e.g., processing resources, memory resources, communication resources, and/or power resources, among other examples) of the user device are utilized to enable review and editing of the portion of the text content.

Additionally, or alternatively, some implementations enable the text editing system to obtain a user indication input associated with the portion of the text content, which may indicate that the portion of the text content is to be saved as a primary version of the portion of the text content or as an alternate version of the portion of the text content. Accordingly, the text editing system updates the editing information, such that the version information of the editing information includes the portion of the text content as a latest saved primary version of the portion of the text content or as a latest saved alternate version of the portion of the text content. The text editing system then transmits the updated editing information to the user device, which allows the user device to display the updated editing information (e.g., contemporaneously with the portion of the text content) to further facilitate editing of the portion of the text content.

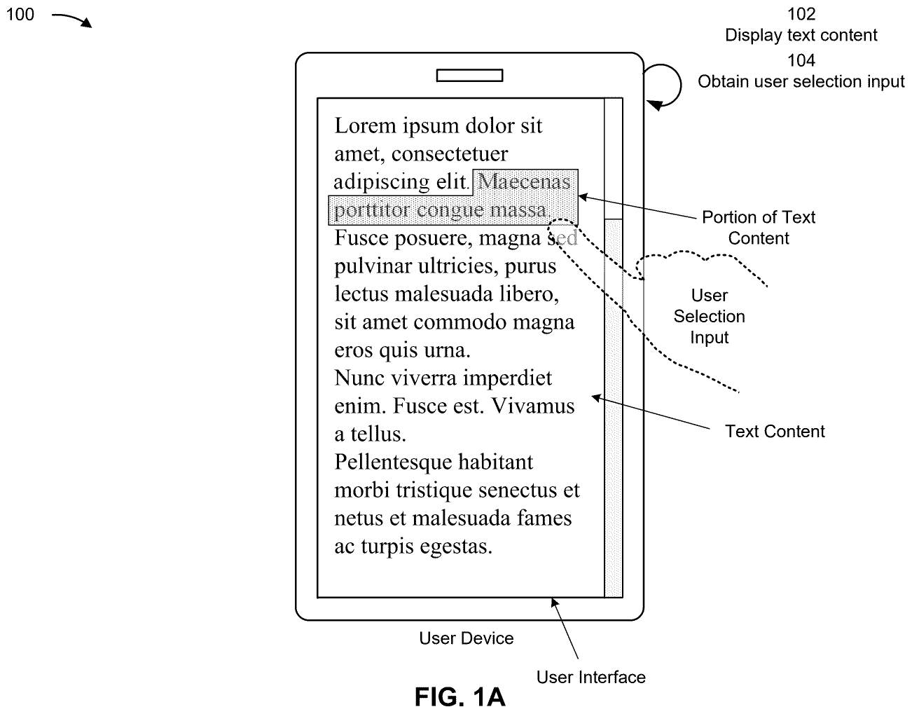

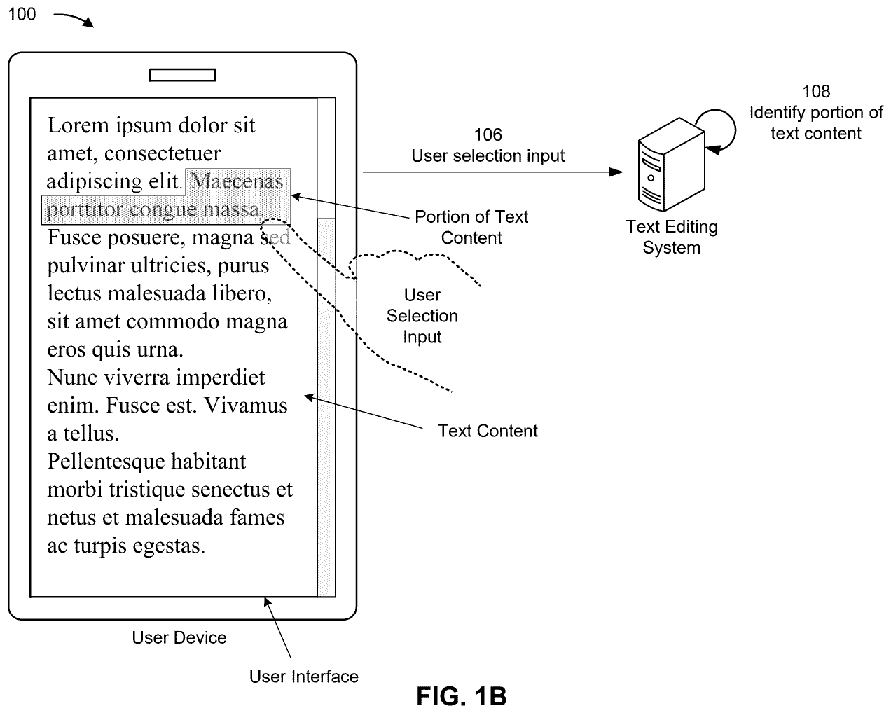

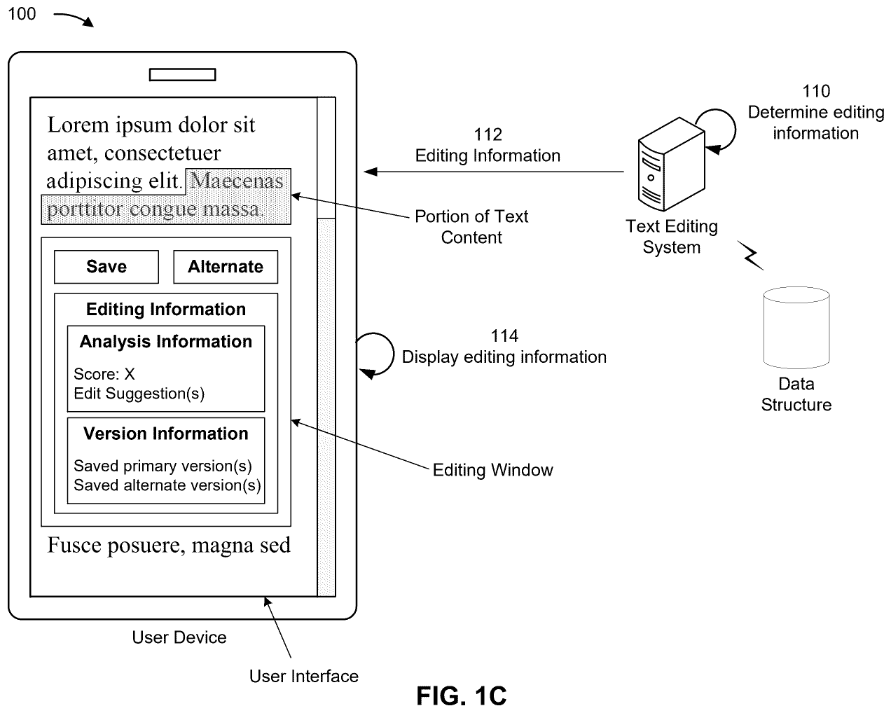

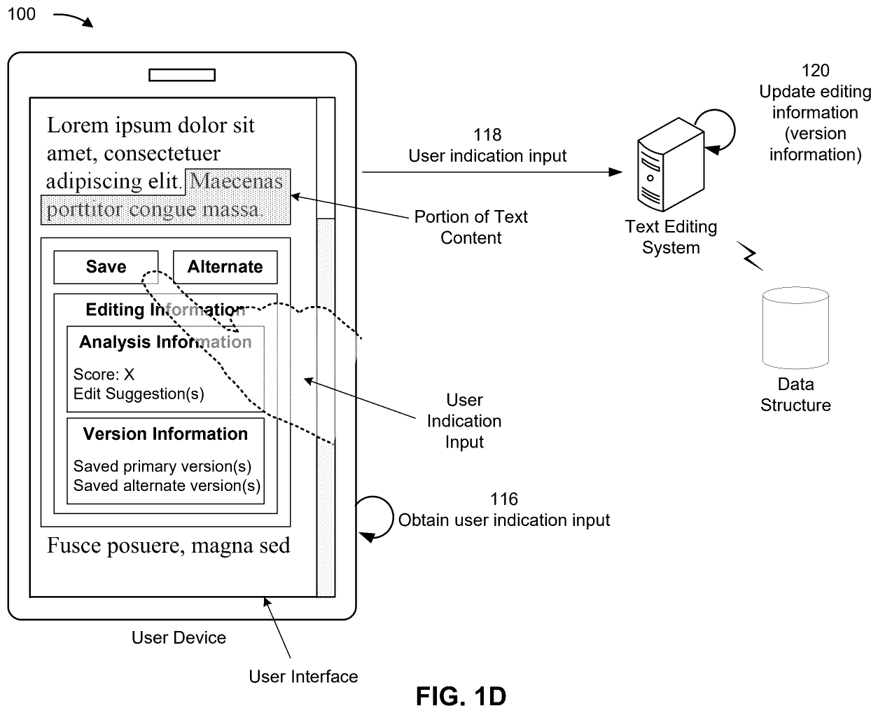

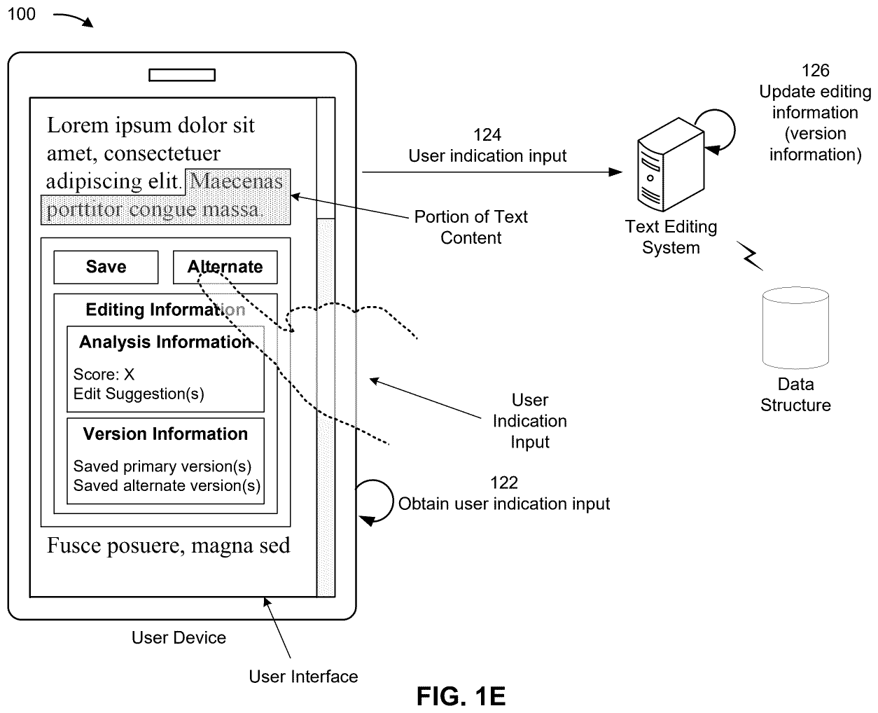

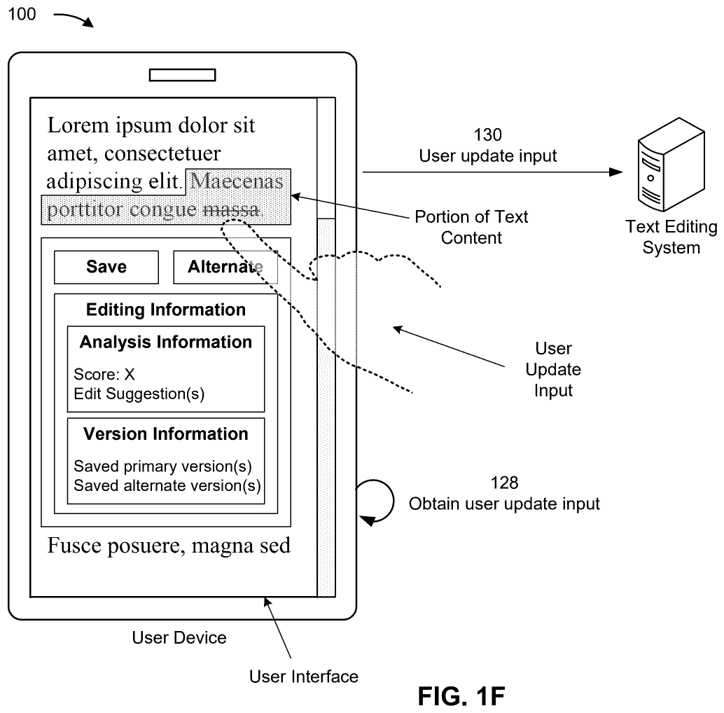

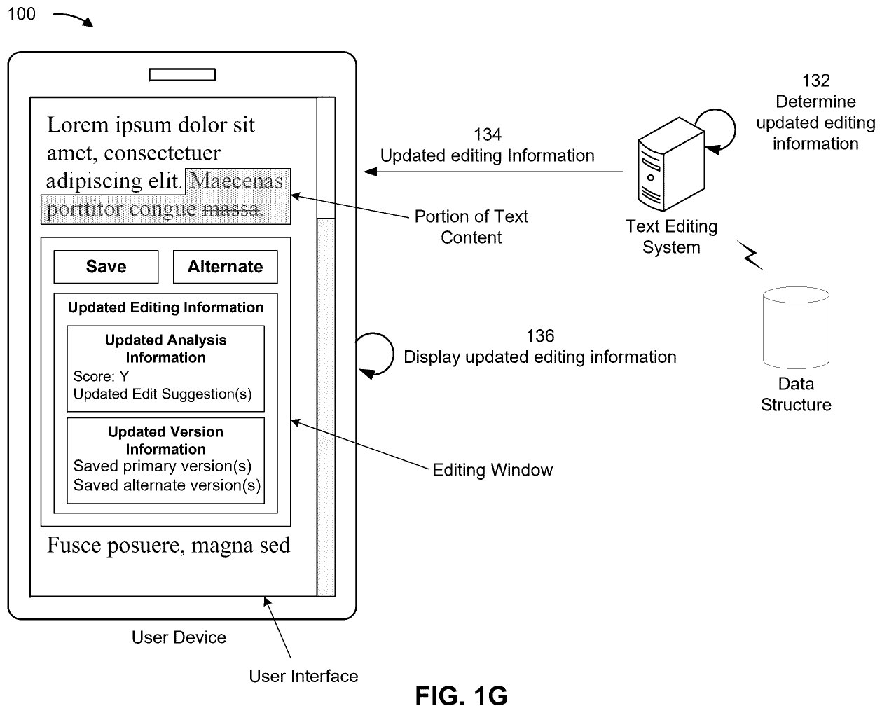

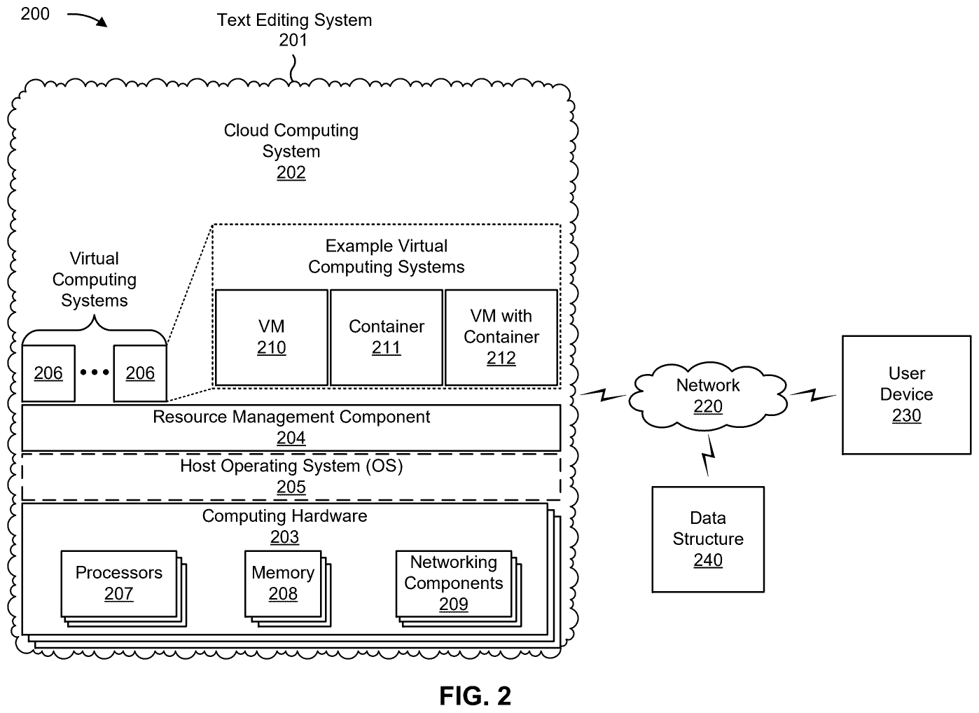

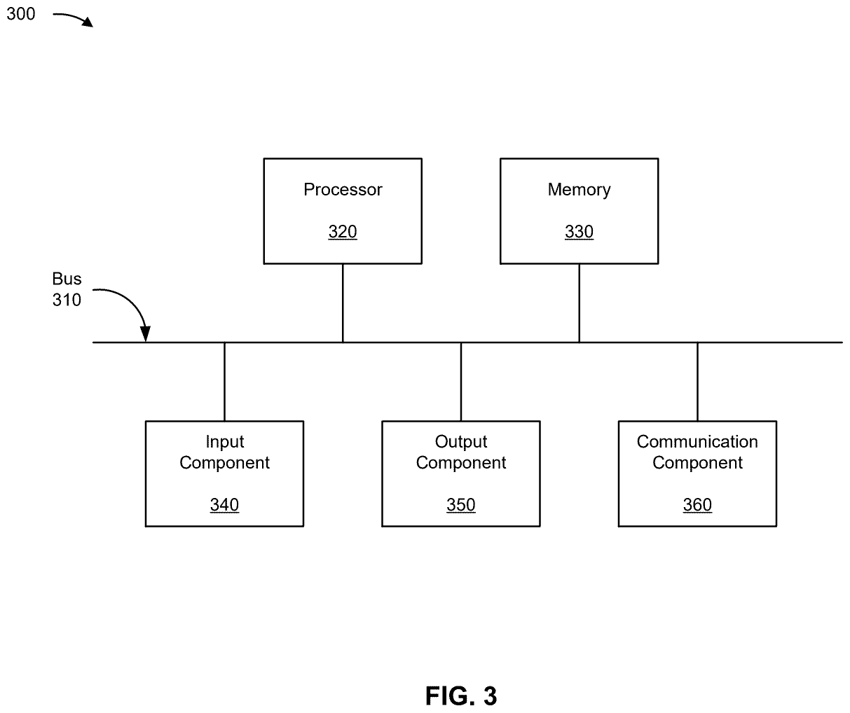

FIGS. 1A-1G are diagrams of an example implementation 100 associated with a system for facilitating text editing. As shown in FIGS. 1A-1G, example implementation 100 includes a text editing system, a user device, and a data structure. These devices are described in more detail below in connection with FIG. 2 and FIG. 3. The user device may be associated with a user. The user device may implement a user interface (e.g., a graphical user interface), such as a text editor, a web browser, or a similar interface. For example, the user device may include a text editor application, which the user device may execute to edit text content.

As shown in FIG. 1A, and by reference number 102, the user device may display text content. The text content may include one or more alphanumeric characters, one or more words, one or more paragraphs, and/or other text content. As an example, as shown in FIG. 1A, the text content includes “Lorem ipsum” placeholder text.

As further shown in FIG. 1A, the user device may display the text content via the user interface of the user device. For example, the user interface may display the text content such that the user of the user device is able to read, navigate, and/or edit the text content (e.g., by interacting with the user interface).

As shown by reference number 104, the user device may obtain user selection input. The user selection input may indicate a portion of the text content. The portion of the text may include some or all of the text content, such as a subset of characters, words, or paragraphs of the text content. As an example, as shown in FIG. 1A, the portion of the text content includes the sentence “Maecenas portitor congue massa” of the “Lorem ipsum” placeholder text.

In some implementations, the user of the user device may interact with the user interface to allow the user device to obtain the user selection input. For example, as shown in FIG. 1A, the user may interact with the user interface to select the portion of the text content (e.g., by highlighting or otherwise marking the portion of the text content) and thereby provide the user selection input to the user device.

As shown in FIG. 1B, and by reference number 106, the user device may transmit the user selection input to the text editing system. For example, the user device may transmit the user selection input to the text editing system in order for the text editing system to determine and provide editing information associated with the portion of the text content, as further described herein. Accordingly, the text editing system may obtain the user selection input, such as by receiving the user selection input from the user device.

In some implementations, the user device may transmit the user selection input to the text editing system in real-time (or near real-time). For example, the user device may transmit the user selection input after (e.g., without delay, or with a delay on the order of seconds or less) the user device obtains the user selection input.

As shown by reference number 108, the text editing system may identify the portion of the text content (e.g., based on the user selection input). For example, the text editing system may process (e.g., read, parse, and/or perform another processing operation on) the user selection input to identify the portion of the text content (e.g., when the user selection input indicates the portion of the text content).

As shown in FIG. 1C, and by reference number 110, the text editing system may determine editing information associated with the portion of the text content. The editing information may include analysis information associated with the portion of the text content and/or version information associated with the portion of the text content. The analysis information may include, for example, a score that indicates a quality of the portion of the text content and/or one or more edit suggestions associated with the portion of the text content, as further described herein. The version information may include, for example, primary version information (e.g., that includes at least a latest saved primary version of the portion of the text content) and/or alternate version information (e.g., that includes one or more saved alternate versions of the portion of the text content), as further described herein.

In some implementations, the text editing system may process the portion of the text content (e.g., at least some of the portion of the text content) to determine the analysis information (e.g., that is included in the editing information). For example, the text editing system may utilize a scoring technique to process the portion of the text content and therefore determine a score associated with the portion of the text content (e.g., a score that indicates a quality of the portion of the text content). The scoring technique may include identifying (e.g., using natural language processing (NLP), and/or another technique) one or more parameters associated with the portion of the text content, such as a length of the portion of the text content, a complexity of the portion of the text content, one or more keywords of the portion of the text content, one or more power words of the portion of the text content, a tense of one or more words of the portion of the text content, and/or a sentiment of the portion of the text content, among other examples. Accordingly, the scoring technique may include processing (e.g., using artificial intelligence (AI), a machine learning model (MLM), and/or another technique) the one or more parameters to determine the score. The score may be, for example, a numeric score that indicates a quality of the portion of the text content based on its position on a scale from a minimum score value to a maximum score value. As an example, as shown in FIG. 1C, the score associated with the portion of the text content is “X”.

As an additional, or alternative, example, the text editing system may utilize a text analysis technique to process the portion of the text content and therefore determine one or more edit suggestions associated with the portion of the text content. The one or more edit suggestions may include grammatical suggestions, spelling suggestions, punctuation suggestions, word choice suggestions, tone suggestions, style suggestions, clarity suggestions, conciseness suggestions, and/or consistency suggestions, among other examples, that are associated with the portion of the text content. The text analysis technique may include using NLP, AI, and/or an MLM, to process the portion of the text content and/or the one or more parameters associated with the portion of the text content to determine the one or more edit suggestions.

In some implementations, the text editing system may communicate with a data structure to determine the version information (e.g., that is included in the editing information). For example, the text editing system may provide information identifying the portion of the text content to the data structure, and the data structure, based on the information, may search for, identify, and provide the version information. The data structure may be included in the text editing system and/or may be accessible to the text editing system (e.g., to allow the text editing system to access information stored by the first data structure).

The data structure may be configured to store primary version information associated with the portion of the text content and/or alternate version information associated with the portion of the text content. The primary version information may include at least a latest saved primary version of the portion of the text content. For example, the primary version information may include a “current” primary version of the portion of the text content (e.g., an exact copy of the portion of the text content as indicated by the user selection input, which may be saved in the data structure in association with the data structure storing the text content). Optionally, the primary version information may also include one or more previous primary versions of the portion of the text content (e.g., that were saved as a result of the user device previously obtaining user indication inputs to save the one or more previous primary versions, respectively, as further described herein). In this way, the primary version information may include one or more primary versions of the portion of the text content that were subjects of a deliberate save process, as further described herein.

The alternate version information may include one or more saved alternate versions of the portion of the text content. For example, the alternate version information may include one or more alternate versions of the portion of the text content that were saved as a result of the user device previously obtaining user indication inputs to save the one or more alternate versions, respectively, as further described herein. In this way, the alternate version information may include one or more alternate versions of the portion of the text content that were subjects of a deliberate save process, as further described herein.

As shown by reference number 112, the text editing system may transmit the editing information to the user device. For example, the text editing system may transmit the editing information to the user device for the user device to display the editing information, as further described herein. Accordingly, the user device may obtain the editing information, such as by receiving the editing information from the text editing system.

As shown by reference number 114, the user device may display the editing information. For example, as shown in FIG. 1C, the user device may display the editing information via the user interface of the user device (e.g., in an editing window of the user interface). In some implementations, the user device may display the editing information (e.g., via the user interface) in association with the portion of the text content. That is, the user device may display at least some of the portion of the text content in a first section of the user interface and may display at least some of the editing information in a second section of the user interface (e.g., at a same time). In this way, displaying the editing information enables contemporaneous display (e.g., on the user device and via the user interface) of at least some of the portion of the text content and at least some of the editing information.

As shown in FIG. 1D, and by reference number 116, the user device may obtain user indication input associated with the portion of the text content. The user indication input may indicate that the portion of the text content is to be saved as a primary version of the portion of the text content. As an example, as shown in FIG. 1D, the user indication input may indicate that the portion of the text content, which includes the sentence “Maecenas portitor congue massa” of the “Lorem ipsum” placeholder text, is to be saved as a primary version of the portion of the text content.

In some implementations, the user of the user device may interact with the user interface to allow the user device to obtain the user indication input. For example, as shown in FIG. 1D, the user may interact with the user interface to select a “save” button (e.g., by “tapping,” “clicking,” or otherwise engaging the save button) and thereby provide the user indication input to the user device.

As shown in FIG. 1D, and by reference number 118, the user device may transmit the user indication input to the text editing system. For example, the user device may transmit the user indication input to the text editing system for the text editing system to update the editing information associated with the portion of the text content, as further described herein. Accordingly, the text editing system may obtain the user indication input, such as by receiving the user indication input from the user device.

In some implementations, the user device may transmit the user indication input to the text editing system in real-time (or near real-time). For example, the user device may transmit the user indication input after (e.g., without delay, or with a delay on the order of seconds or less) the user device obtains the user indication input.

As shown by reference number 120, the text editing system may update the editing information. For example, the text editing system may cause the version information to include the portion of the text content as a latest saved primary version of the portion of the text content. That is, the text editing system may communicate with the data structure to cause the data structure to save the portion of the text content as a latest saved primary version of the portion of the text content (e.g., as a part of the primary version information of the version information).

As shown in FIG. 1E, and by reference number 122, the user device may obtain user indication input associated with the portion of the text content. The user indication input may indicate that the portion of the text content is to be saved as an alternate version of the portion of the text content. As an example, as shown in FIG. 1E, the user indication input may indicate that the portion of the text content, which includes the sentence “Maecenas portitor congue massa” of the “Lorem ipsum” placeholder text, is to be saved as an alternate version of the portion of the text content.

In some implementations, the user of the user device may interact with the user interface to allow the user device to obtain the user indication input. For example, as shown in FIG. 1E, the user may interact with the user interface to select an “alternate” button (e.g., by tapping, clicking, or otherwise engaging the alternate button) and thereby provide the user indication input to the user device.

As shown in FIG. 1E, and by reference number 124, the user device may transmit the user indication input to the text editing system. For example, the user device may transmit the user indication input to the text editing system for the text editing system to update the editing information associated with the portion of the text content, as further described herein. Accordingly, the text editing system may obtain the user indication input, such as by receiving the user indication input from the user device.

In some implementations, the user device may transmit the user indication input to the text editing system in real-time (or near real-time). For example, the user device may transmit the user indication input after (e.g., without delay, or with a delay on the order of seconds or less) the user device obtains the user indication input.

As shown by reference number 126, the text editing system may update the editing information. For example, the text editing system may cause the version information to include the portion of the text content as a latest saved alternate version of the portion of the text content. That is, the text editing system may communicate with the data structure to cause the data structure to save the portion of the text content as a latest saved alternate version of the portion of the text content (e.g., as a part of the alternate version information of the version information).

As shown in FIG. 1F, and by reference number 128, the user device may obtain user update input associated with the portion of the text content. The user update input may indicate one or more updates (e.g., one or more additions, changes, and/or deletions) to the portion of the text content. As an example, as shown in FIG. 1F, the user indication input may indicate that the last word (“massa”) of the portion of the text content, which includes the sentence “Maecenas portitor congue massa” of the “Lorem ipsum” placeholder text, is to be deleted from the portion of the text content.

In some implementations, the user of the user device may interact with the user interface to allow the user device to obtain the user update input. For example, as shown in FIG. 1F, the user may interact with the user interface to indicate the one or more updates to the portion of the text content and thereby provide the user update input to the user device.

As shown in FIG. 1F, and by reference number 130, the user device may transmit the user update input to the text editing system. For example, the user device may transmit the user update input to the text editing system for the text editing system to determine updated editing information, as further described herein. Accordingly, the text editing system may obtain the user update input, such as by receiving the user update input from the user device.

In some implementations, the user device may transmit the user update input to the text editing system in real-time (or near real-time). For example, the user device may transmit the user update input after (e.g., without delay, or with a delay on the order of seconds or less) the user device obtains the user update input.

As shown in FIG. 1G, and by reference number 132, the text editing system may determine updated editing information, such as in a similar manner as that described herein in relation to FIG. 1C and reference number 110. The updated editing information may include, for example, updated analysis information associated with the portion of the text content and/or updated version information associated with the portion of the text content. The updated analysis information may include, for example, an updated score (e.g., that indicates a quality of the portion of the text content with the one or more updates to the portion of the text content) and/or one or more updated edit suggestions associated with the portion of the text content, as further described herein. The updated version information may include, for example, updated primary version information and/or updated alternate version information, as further described herein.

In some implementations, the text editing system may process the portion of the text content (e.g., at least some of the portion of the text content) and/or the one or more updates to the portion of the text content to determine the updated analysis information (e.g., that is included in the text editing information). For example, the text editing system may utilize the scoring technique (described elsewhere herein) to process the portion of the text content and/or the one or more updates to the portion of the text content to determine an updated score associated with the portion of the text content. FIG. 1G shows an example where the updated score associated with the portion of the text content is “Y.” As an additional, or alternative, example, the text editing system may utilize the text analysis technique (described elsewhere herein) to process the portion of the text content and/or the one or more updates to the portion of the text content to determine one or more updated edit suggestions associated with the portion of the text content. The one or more updated edit suggestions may be similar types of suggestions as the edit suggestions described herein.

In some implementations, the text editing system may communicate with the data structure to determine the updated version information (e.g., that is included in the updated editing information), such as in a similar manner at that described herein. For example, the text editing system may obtain updated primary version information (e.g., that includes the primary version information described herein and/or one or more updates to the primary version information) and/or updated alternate version information (e.g., that includes the alternate version information described herein and/or one or more updates to the alternate version information) from the data structure.

As shown by reference number 134, the text editing system may transmit the updated editing information to the user device. For example, the text editing system may transmit the updated editing information to the user device for the user device to display the updated editing information, as further described herein. Accordingly, the user device may obtain the updated editing information, such as by receiving the updated editing information from the text editing system.

As shown by reference number 136, the user device may display the updated editing information. For example, as shown in FIG. 1G, the user device may display the updated editing information via the user interface of the user device (e.g., in the editing window of the user interface). In some implementations, the user device may display the updated editing information (e.g., via the user interface) in association with the portion of the text content (and the one or more updates to the text content). That is, the user device may display at least some of the portion of the text content and/or the one or more updates to the text content in a first section of the user interface, and may display at least some of the updated editing information in a second section of the user interface (e.g., at a same time). In this way, displaying the updated editing information enables contemporaneous display (e.g., on the user device and via the user interface) of at least some of the portion of the text content and/or the one or more updates to the portion of the text content and at least some of the updated editing information.

As indicated above, FIGS. 1A-1G are provided as an example. Other examples may differ from what is described with regard to FIGS. 1A-1G. The number and arrangement of devices shown in FIGS. 1A-1G are provided as an example. In practice, there may be additional devices, fewer devices, different devices, or differently arranged devices than those shown in FIGS. 1A-1G. Furthermore, two or more devices shown in FIGS. 1A-1G may be implemented within a single device, or a single device shown in FIGS. 1A-1G may be implemented as multiple, distributed devices. Additionally, or alternatively, a set of devices (e.g., one or more devices) shown in FIGS. 1A-1G may perform one or more functions described as being performed by another set of devices shown in FIGS. 1A-1G.

FIG. 2 is a diagram of an example environment 200 in which systems and/or methods described herein may be implemented. As shown in FIG. 2, environment 200 may include a text editing system 201, which may include one or more elements of and/or may execute within a cloud computing system 202. The cloud computing system 202 may include one or more elements 203-212, as described in more detail below. As further shown in FIG. 2, environment 200 may include a network 220, a user device 230, and/or a data structure 240. Devices and/or elements of environment 200 may interconnect via wired connections and/or wireless connections.

The cloud computing system 202 may include computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from computing hardware 203 of the single computing device. In this way, computing hardware 203 can operate more efficiently, with lower power consumption, higher reliability, higher availability, higher utilization, greater flexibility, and lower cost than using separate computing devices.

The computing hardware 203 may include hardware and corresponding resources from one or more computing devices. For example, computing hardware 203 may include hardware from a single computing device (e.g., a single server) or from multiple computing devices (e.g., multiple servers), such as multiple computing devices in one or more data centers. As shown, computing hardware 203 may include one or more processors 207, one or more memories 208, and/or one or more networking components 209. Examples of a processor, a memory, and a networking component (e.g., a communication component) are described elsewhere herein.

The resource management component 204 may include a virtualization application (e.g., executing on hardware, such as computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 210. Additionally, or alternatively, the resource management component 204 may include a container manager, such as when the virtual computing systems 206 are containers 211. In some implementations, the resource management component 204 executes within and/or in coordination with a host operating system 205.

A virtual computing system 206 may include a virtual environment that enables cloud-based execution of operations and/or processes described herein using computing hardware 203. As shown, a virtual computing system 206 may include a virtual machine 210, a container 211, or a hybrid environment 212 that includes a virtual machine and a container, among other examples. A virtual computing system 206 may execute one or more applications using a file system that includes binary files, software libraries, and/or other resources required to execute applications on a guest operating system (e.g., within the virtual computing system 206) or the host operating system 205.

Although the text editing system 201 may include one or more elements 203-212 of the cloud computing system 202, may execute within the cloud computing system 202, and/or may be hosted within the cloud computing system 202, in some implementations, the text editing system 201 may not be cloud-based (e.g., may be implemented outside of a cloud computing system) or may be partially cloud-based. For example, the text editing system 201 may include one or more devices that are not part of the cloud computing system 202, such as device 300 of FIG. 3, which may include a standalone server or another type of computing device. The text editing system 201 may perform one or more operations and/or processes described in more detail elsewhere herein.

The network 220 may include one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The user device 230 may include one or more devices capable of receiving, generating, storing, processing, and/or providing information associated, as described elsewhere herein. The user device 230 may include a communication device and/or a computing device. For example, the user device 230 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The data structure 240 may include one or more devices capable of receiving, generating, storing, processing, and/or providing information associated, as described elsewhere herein. The data structure 240 may include a communication device and/or a computing device. For example, the data structure 240 may include a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the data structure 240 may store version information, as described elsewhere herein.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300 associated with a system for facilitating text editing. The device 300 may correspond to the text editing system 201, the computing hardware 203, the user device 230, and/or the data structure 240. In some implementations, the text editing system 201, the computing hardware 203, the user device 230, and/or the data structure 240 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

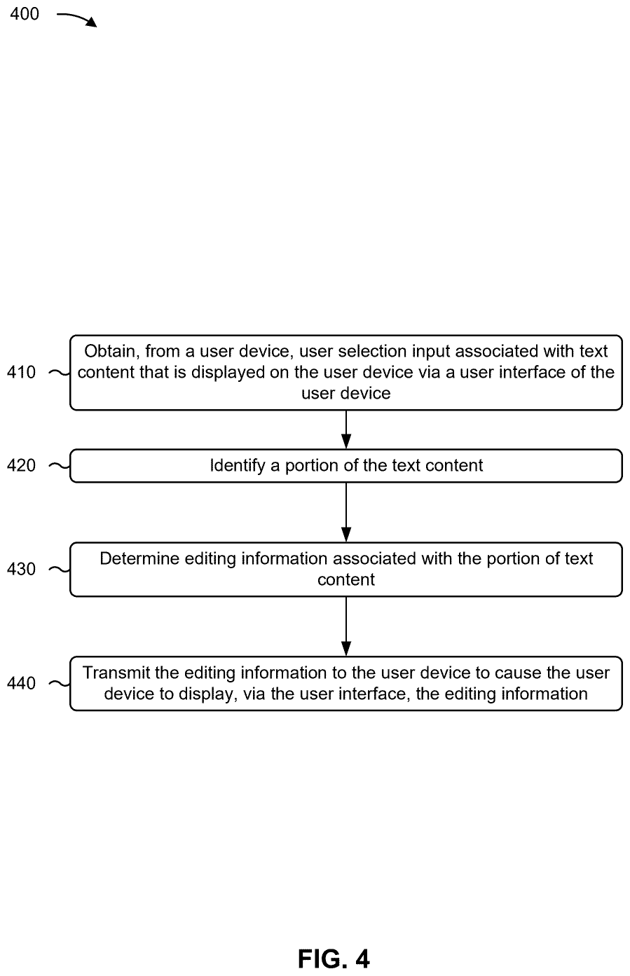

FIG. 4 is a flowchart of an example process 400 associated with a system for facilitating text editing. In some implementations, one or more process blocks of FIG. 4 may be performed by the text editing system 201. In some implementations, one or more process blocks of FIG. 4 may be performed by another device or a group of devices separate from or including the text editing system 201, such as the computing hardware 203, the user device 230, and/or the data structure 240. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include obtaining, from a user device, user selection input associated with text content that is displayed on the user device via a user interface of the user device (block 410). For example, the text editing system 201 (e.g., using processor 320, memory 330, input component 340, and/or communication component 360) may obtain, from a user device, user selection input associated with text content that is displayed on the user device via a user interface of the user device, as described above in connection with reference number 106 of FIG. 1B. As an example, the user device may transmit the user selection input to the text editing system 201 for the text editing system 201 to determine and provide editing information associated with the portion of the text content, as described herein.

As further shown in FIG. 4, process 400 may include identifying, based on the user selection input, a portion of the text content (block 420). For example, the text editing system 201 (e.g., using processor 320 and/or memory 330) may identify, based on the user selection input, a portion of the text content, as described above in connection with reference number 108 of FIG. 1B. As an example, the text editing system 201 may process (e.g., read, parse, and/or perform another processing operation on) the user selection input to identify the portion of the text content, as described herein.

As further shown in FIG. 4, process 400 may include determining editing information associated with the portion of text content (block 430). For example, the text editing system 201 (e.g., using processor 320 and/or memory 330) may determine editing information associated with the portion of text content, as described above in connection with reference number 110 of FIG. 1C. In some implementations, the editing information includes analysis information associated with the portion of the text content and version information associated with the portion of the text content. As an example, the text editing system 201 may process the portion of the text content (e.g., at least some of the portion of the text content) to determine the analysis information (e.g., that is included in the editing information) and/or may communicate with a data structure to determine the version information (e.g., that is included in the editing information).

As further shown in FIG. 4, process 400 may include transmitting the editing information to the user device to cause the user device to display, via the user interface, the editing information (block 440). For example, the text editing system 201 (e.g., using processor 320, memory 330, output component 350, and/or communication component 360) may transmit the editing information to the user device to cause the user device to display, via the user interface, the editing information, as described above in connection with reference numbers 112 and 114 of FIG. 1C. As an example, the text editing system may transmit the editing information to the user device to enable contemporaneous display (e.g., on the user device and via the user interface) of at least some of the portion of the text content and at least some of the editing information.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1G. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

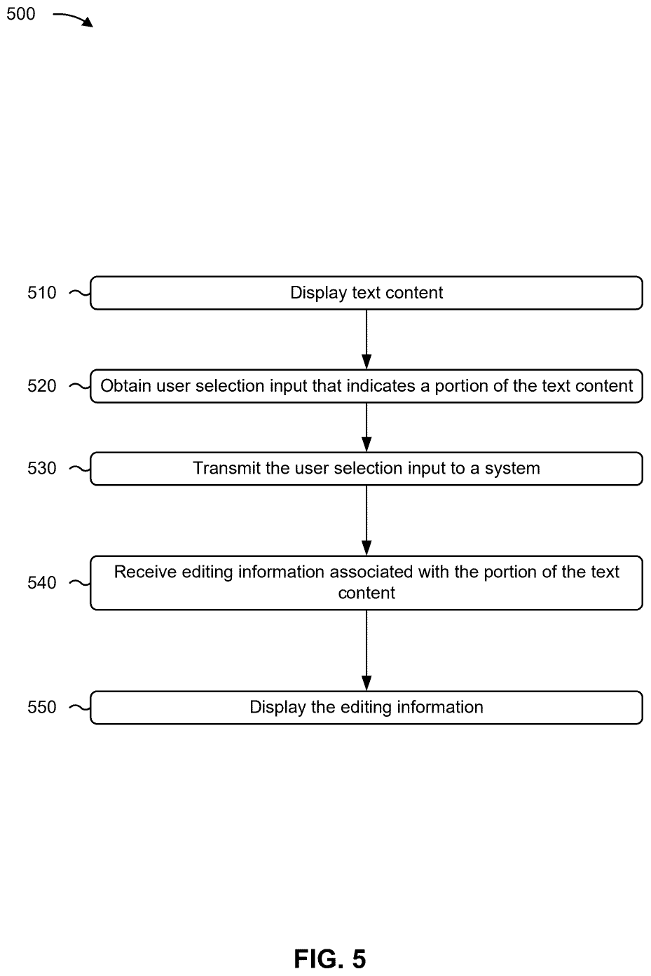

FIG. 5 is a flowchart of an example process 500 associated with a system for facilitating text editing. In some implementations, one or more process blocks of FIG. 5 may be performed by the user device 230. In some implementations, one or more process blocks of FIG. 5 may be performed by another device or a group of devices separate from or including the user device 230, such as the text editing system 201, the computing hardware 203, and/or the data structure 240. Additionally, or alternatively, one or more process blocks of FIG. 5 may be performed by one or more components of the device 300, such as processor 320, memory 330, input component 340, output component 350, and/or communication component 360.

As shown in FIG. 5, process 500 may include displaying text content (block 510). For example, the user device 230 (e.g., using processor 320, memory 330, and/or output component 350) may display text content, as described above in connection with reference number 102 of FIG. 1A. As an example, the user device 230 may display text content via a user interface of the user device 230.

As further shown in FIG. 5, process 500 may include obtaining user selection input that indicates a portion of the text content (block 520). For example, the user device 230 (e.g., using processor 320, memory 330, and/or input component 340) may obtain user selection input that indicates a portion of the text content, as described above in connection with reference number 104 of FIG. 1A. As an example, a user of the user device 230 may interact with the user interface to allow the user device 230 to obtain the user selection input.

As further shown in FIG. 5, process 500 may include transmitting the user selection input to a system (block 530). For example, the user device 230 (e.g., using processor 320, memory 330, and/or communication component 360) may transmit the user selection input to a system, as described above in connection with reference number 106 of FIG. 1B. As an example, the user device 230 may transmit the user selection input to the system for the system to determine and provide editing information associated with the portion of the text content, as described herein.

As further shown in FIG. 5, process 500 may include receiving, based on transmitting the user selection input, editing information associated with the portion of the text content (block 540). For example, the user device 230 (e.g., using processor 320, memory 330, input component 340, and/or communication component 360) may receive, based on transmitting the user selection input, editing information associated with the portion of the text content, as described above in connection with reference number 112 of FIG. 1C. As an example, the system may transmit the editing information to the user device 230 for the user device 230 to display the editing information, as further described herein. In some implementations, the editing information includes analysis information associated with the portion of the text content and version information associated with the portion of the text content.

As further shown in FIG. 5, process 500 may include displaying the editing information (block 550). For example, the user device 230 (e.g., using processor 320, memory 330, and/or output component 350) may display the editing information, as described above in connection with reference number 114 of FIG. 1C. As an example, the user device 230 may display the editing information via the user interface of the user device.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1G. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for facilitating text editing, the system comprising:
one or more memories; and
one or more processors, communicatively coupled to the one or more memories, configured to:
obtain, from a user device, user selection input associated with text content that is displayed on the user device via a user interface of the user device;
identify, based on the user selection input, a portion of the text content;
determine editing information associated with the portion of text content,
wherein the editing information includes analysis information associated with the portion of the text content and version information associated with the portion of the text content; and
transmit the editing information to the user device to cause the user device to display, via the user interface, the editing information.

2. The system of claim 1, wherein the analysis information includes a score that indicates a quality of the portion of the text content.

3. The system of claim 1, wherein the analysis information includes one or more edit suggestions associated with the portion of the text content.

4. The system of claim 1, wherein the version information includes primary version information that includes at least a latest saved primary version of the portion of the text content.

5. The system of claim 1, wherein the version information includes alternate version information that includes one or more saved alternate versions of the portion of the text content.

6. The system of claim 1, wherein the one or more processors are further configured to:
obtain, from the user device, user update input associated with the portion of the text content;
determine, based on the user update input, updated editing information associated with the portion of the text content,
wherein the updated editing information includes updated analysis information associated with the portion of the text content and updated version information associated with the portion of the text content; and
transmit the updated editing information to the user device to enable the user device to display, via the user interface, the updated editing information.

7. The system of claim 1, wherein the one or more processors are further configured to:
obtain, from the user device, user indication input that indicates that the portion of the text content is to be saved as a primary version of the portion of the text content; and
cause the version information to include the portion of the text content as a latest saved primary version of the portion of the text content.

8. The system of claim 1, wherein the one or more processors are further configured to:
obtain, from the user device, user indication input that indicates that the portion of the text content is to be saved as an alternate version of the portion of the text content; and
cause the version information to include the portion of the text content as a latest saved alternate version of the portion of the text content.

9. A non-transitory computer-readable medium storing a set of instructions, the set of instructions comprising:
one or more instructions that, when executed by one or more processors of a system, cause the system to:
identify a portion of text content that is displayed on a user device via a user interface of the user device;
determine editing information associated with the portion of the text content,
wherein the editing information includes analysis information associated with the portion of the text content and version information associated with the portion of the text content; and
transmit the editing information to the user device to enable the user device to display, via the user interface, the editing information.

10. The non-transitory computer-readable medium of claim 9, wherein the one or more instructions, that cause the system to determine the editing information, cause the system to:
process the portion of the text content to determine the analysis information.

11. The non-transitory computer-readable medium of claim 9, wherein the analysis information includes at least one of:
a score that indicates a quality of the portion of the text content; or
one or more edit suggestions associated with the portion of the text content.

12. The non-transitory computer-readable medium of claim 9, wherein the one or more instructions, that cause the system to determine the editing information, cause the system to:
communicate with a data structure to determine the version information.

13. The non-transitory computer-readable medium of claim 9, wherein the version information includes at least one of:
at least a latest saved primary version of the portion of the text content; or
one or more saved alternate versions of the portion of the text content.

14. The non-transitory computer-readable medium of claim 9, wherein the one or more instructions further cause the system to:
identify user indication input that indicates that the portion of the text content is to be saved as a primary version of the portion of the text content; and
cause the version information to include the portion of the text content as a latest saved primary version of the portion of the text content.

15. The non-transitory computer-readable medium of claim 9, wherein the one or more instructions further cause the system to:
identify user indication input that indicates that the portion of the text content is to be saved as an alternate version of the portion of the text content; and
cause the version information to include the portion of the text content as a latest saved alternate version of the portion of the text content.

16. A method, comprising:
displaying, by a user device and via a user interface of the user device, text content;
obtaining, by the user device and based on displaying the text content, user selection input that indicates a portion of the text content;
transmitting, by the user device, the user selection input to a system;
receiving, by the user device and based on transmitting the user selection input, editing information associated with the portion of the text content,
wherein the editing information includes analysis information associated with the portion of the text content and version information associated with the portion of the text content; and
displaying, by the user device and via the user interface of the user device, the editing information.

17. The method of claim 16, wherein displaying the editing information enables contemporaneous display, on the user device and via the user interface, of at least some of the portion of the text content and at least some of the editing information.

18. The method of claim 16, wherein the analysis information includes at least one of:
a score that indicates a quality of the portion of the text content; or
one or more edit suggestions associated with the portion of the text content.

19. The method of claim 16, wherein the version information includes at least one of:
at least a latest saved primary version of the portion of the text content; or
one or more saved alternate versions of the portion of the text content.

20. The method of claim 16, further comprising:
obtaining, via the user interface, user indication input that indicates that the portion of the text content is to be saved as one of:
a primary version of the portion of the text content, or
an alternate version of the portion of the text content; and
transmitting the user indication input to the system to enable update of the version information.
